(19) United States
(12) Patent Application Publication
(10) Pub. No.: US 2017/0069006 A1
(43) Pub. Date: Mar. 9, 2017

(54) SYSTEM AND METHOD FOR PRODUCING QUOTES

(71) Applicant: Brian Semling, Fountain City, WI (US)

(72) Inventor: Brian Semling, Fountain City, WI (US)

(21) Appl. No.: 15/255,608

(22) Filed: Sep. 2, 2016

Related U.S. Application Data
(60) Provisional application No. 62/214,182, filed on Sep. 3, 2015.

(51) Int. Cl. G06Q 30/06; G06Q 10/10

(52) U.S. Cl. CPC G06Q 30/0613; G06Q 10/107

(57) ABSTRACT

A method and a system for communication between a seller and a potential buyer are provided. The method and the system comprises at least one server in communication with a wireless data network and a mobile wireless device in communication with the at least one server using the wireless data network. The system and the method for communication between the seller and the potential buyer facilitates searching based on a distance from the seller and simplifies a procedure for the buyer to produce quotes for items a store owner wishes to buy from a user. In specific embodiments, the items may be items of value in the secondary toy/collector market, other collectible markets, books, or any market where items can be identified by UPC bar codes and scanned by users.

### FIELD OF THE INVENTION

The present invention relates to a system and a method for communication that allows the owner of an item(s) (collectible toy, book, other collectible) to easily and efficiently determine the price a buyer will pay for this item, preferably using a mobile wireless device. The system also streamlines the process of selling the item from owner to buyer if the owner decides to proceed with the sale of the item(s). In more specific embodiments, the quotes are based on a specialized database configured for the secondary or collectible toy market, other collectibles, books, or other items with UPC bar codes.

### BACKGROUND OF THE INVENTION

Network based quote production aids users of such services in buying or selling items. The item desired can be uniquely identified by its universal price code (UPC). Some non-limiting examples of markets where the system and method described herein would be helpful would be books and toys. In addition, sellers can use offered price values given by a store owner or other buyer to decide whether the value of the collection or individual item is worth selling at that time.

It would be advantageous to develop a system and a method for communication between a seller and a potential buyer using at least one mobile wireless device that facilitates quote production, while providing the seller to edit and categorize potential items for sale in lists and groups. In order to address this need, and to provide sellers with flexibility in designing the groups of items they wish to receive quotes on and/or sell, the invention herein describes an application, method, and system for producing quotes.

### SUMMARY OF THE INVENTION

Presented herein is a system and a-method for communication between a seller and a potential buyer using at least one mobile wireless device that facilitates quote production.

In one embodiment, the present invention is directed to a method of communication between a seller and a potential buyer. The steps of the method include providing at least one server in communication with a data network, receiving at the at least one server a user input from the seller, wherein the user input from the seller include at least one universal price code (UPC), producing price information based on the UPC received, publishing the price information to the at least one server using the data network, viewing the price information by the potential seller on a computing device. A specialized database that produces price information based on the UPC received can also be involved.

Further embodiments may include providing avenues for a seller to refine the list items included in the quote, finalizing the quote, and sending finalized list that serves as quote acceptance to store owner. Store owner can then accept finalized quote and provide shipping information to seller via e-mail or other known methods.

In alternative embodiments, a system for producing price quotes includes at least one server in communication with a data network, the at least one server configured to receive and store a user input from the seller, the user input from the seller including at least one universal price code (UPC), the at least one server publishing a query to the server, the query including at least a portion of the user input from the seller; and

a first computing device in communication with the at least one server using the data network, the computing device configured to produce price information based on the at least one UPC, the at least one server making the price information available on the at least one server.

Various aspects of this invention will become apparent to those skilled in the art from the following detailed description of the preferred embodiment, when read in light of the accompanying drawings.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a flow chart showing the flow of data in accordance with the invention.

FIG. 2 is a schematic diagram of a system for communication between a seller and a potential buyer/store owner.

### DETAILED DESCRIPTION OF THE INVENTION

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

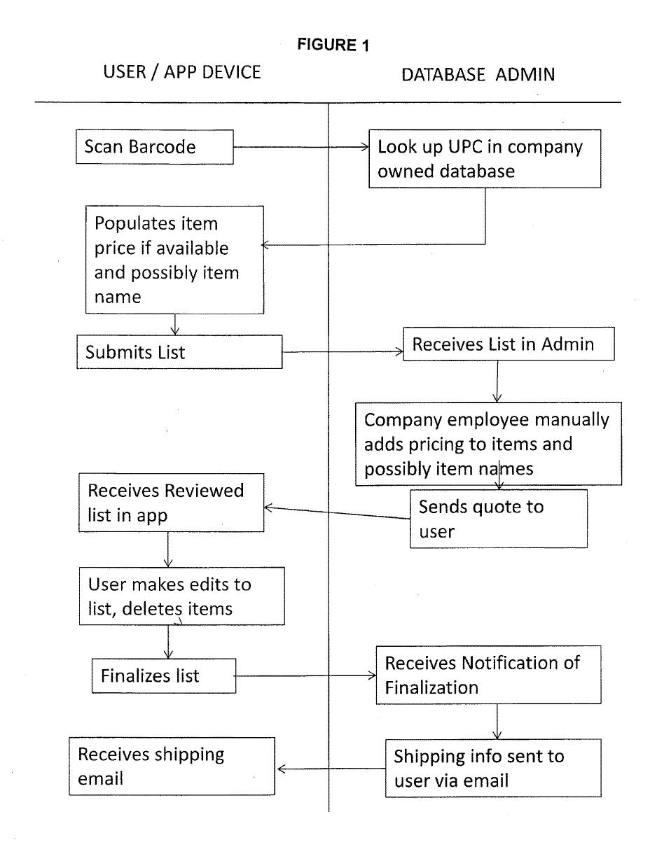

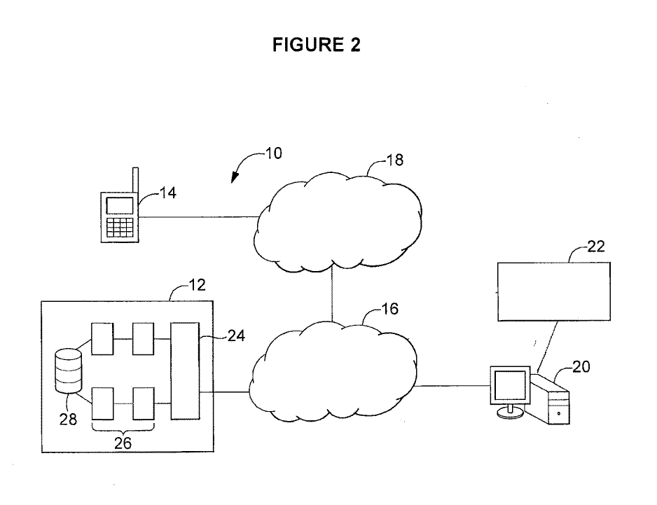

FIG. 1 is a schematic illustrating the flow of data in accordance with an embodiment of the invention. Reference characters, if used, are shown in FIG. 2. The app is designed to aid a store owner to generate an offer associated with the items the user 30 desires to sell using an offer generating function located on the data storage device 28 or store owner's machine 20, to manage the remote applications 22 using an applications management function, to view and send messages using a messaging function, and to edit a plurality of functions of the operations server using a settings function. It is understood that the client interface 24 may be configured to provide other functions not illustrated, such as running of reporting functions, modification of interface settings, as well as other functions. Upon the user 30 having performed the desired tasks, the user 30 sends the list of UPCs they wish to sell to store owner. As is known in the art, the user accesses the system for communication 10. It is understood the system for communication 10 may require a log in and password or may be configured to permit access to portions of the application platform 12 without the need for logging in to the system for communication 10, such as through the use of browser cookies and application information contained on the mobile wireless device 14.

Having accessed system for communication 10, the user 30 has access to a plurality of functions provided by the application platform 12. The user 30 can scan the UPC of an item in user's collection. The operations server 26 is configured to search a store owned, cloud maintained database that links UPC codes of items to prices determined by store owners. The database information is sent to the user device and the user device populates item name and price, if available. The user has the option to manage lists of items in their collection by creating sublists and naming existing lists. Once a user has created a list populated with specific items they are considering selling, the list is selected by the user and sent to the store owner through the network. At this stage, an employee of the store owner manually verifies and updates the pricing of the items. The quote is then sent over the network to the user device. The user then, after reviewing the quote, can then edit or delete items from the quote. Once quote is finalized by user on the user device, the finalized quote is sent over the network to the store owner. Once the finalized quote is received by the store owner, an e-mail is automatically generated informing user of shipping instructions and sent via the network to the user device. The e-mail regarding shipping instructions is received by the user.

Turning now to FIG. 2, a system for communication 10 is shown comprising of an application platform 12, and a mobile wireless device 14. The application platform 12 is in communication with the mobile wireless device 14 via a network 16 (the internet, for example) and a wireless data network 18. A store owner machine 20 is shown in communication with the application platform 12 via the network 16. In certain embodiments, a remote application 22 can communicate with the store owner machine 20. However, it is understood that the system for communication 10 may be operated without the store owner machine 20 or the remote application 22. A user of the system for communication 10 may be a seller or a potential buyer of a good or a service. The seller uses the system for communication 10 to post an offer for the good or the service to the application platform 12 and to communicate with the potential buyer. The potential buyer uses the system for communication 10 to search and/or browse a plurality of offers and to communicate with the seller.

The application platform 12 comprises a plurality of servers in communication with one another. The application platform 12 includes a client interface 24, at least one operations server 26, and a data storage device 28. The application platform 12 provides an interface for the user of the system for communication 10 to interact with and hosts programs facilitating the receiving, manipulating, and sending of data between one of the mobile wireless device 14 and the user machine 20, the data storage device 28, and the remote application 22.

The mobile wireless device 14 is a portable electronic device capable of sending and receiving information from the network 16. As non-limiting examples, the mobile wireless device 14 may be one of a mobile phone, a personal media player, a tablet computer, a notebook computer, a global positioning system (GPS) device, an entertainment receiver installed in a vehicle, a personal digital assistant, a handheld gaming device, and an e-book reading device. Further, it is understood that other devices may be used.

The mobile wireless device 14 may connect to the network 16 using the wireless data network 18. As non-limiting examples, the wireless data network 18 may be a cellular network provided by a network provider, a wireless network access point (such as a router) in communication with the network 16, or an ad-hoc network formed by a plurality of devices capable of communicating wirelessly. The mobile wireless device 14 may be capable of scanning UPCs.

The operations server 26 is at least one computer in communication with the client interface 24 and the data storage device 28. As shown in FIG. 2, the operations server 26 may comprise a plurality of computers in communication with one another. Each of the computers forming the operations server 26 may be dedicated to a function of the application platform 12.

The data storage device 28 is a computer providing a database service as is known in the art. The data storage device 28 is in communication with the operations server 26. As mentioned hereinabove, the data storage device 28, upon request by the operations server 26, stores and retrieves at least a first user input, the offers generated by the operations server 26. It is understood that the data storage device 28 may also be used to store any other information used by the system for communication 10.

In accordance with the provisions of the patent statutes, the invention has been described in what is considered to represent its preferred embodiments. However, it should be noted that the invention can be practiced otherwise than as specifically illustrated and described without departing from its spirit or scope.

What is claimed is:

1. A method of communication between a seller and a potential buyer, the steps of the method comprising:
a. providing at least one server in communication with a data network,
b. receiving at the at least one server a user input from the seller, wherein the user input from the seller includes at least one universal price code (UPC),
c. producing price information based on the UPC received,
d. publishing the price information to the at least one server using the data network,
e. viewing the price information by the potential seller on a computing device.

2. The method of communication according to claim 1, wherein the computing device is a mobile wireless device.

3. The method of communication according to claim 1, wherein the step of publishing the price information to the at least one-server includes displaying at least a portion of the user input based on a preference of the buyer.

4. The method of communication according to claim 1, further comprising the step of receiving at the at least one server a second user input from the potential buyer, the at least one server sending a notification to the seller in response to the second user input from the potential buyer.

5. The method of communication according to claim 4, wherein the notification comprises one of a message written by the potential buyer, a contact information of the potential buyer, and a counteroffer.

6. The method of communication according to claim 5, wherein the notification is one of a text message sent to a second computing device of the seller, an electronic mail sent to an email address of the seller, and a message residing on the at least one server.

7. The method of communication according to claim 1, further comprising the step of receiving at the at least one server a second user input from the potential seller, the at least one server sending a notification to the buyer in response to the second user input from the potential seller.

8. The method of communication according to claim 7, wherein the notification comprises one of a message written by the potential seller, a contact information of the potential buyer, and a counteroffer.

9. The method of communication according to claim 7, wherein the notification is one of a text message sent to the computing device of the buyer, an electronic mail sent to an email address of the buyer, and a message residing on the at least one server.

10. The method of communication according to claim 1, wherein the user of the seller includes at least one of an image, an audio clip, a text description, and a price value.

11. The method of communication according to claim 10, wherein the step of receiving at the at least one server the first user input from the seller further includes performing an image recognition analysis on the image in the first user input.

12. The method of communication according to claim 1, wherein producing price information is based on the UPC received and a specialized database specific to the secondary toy market, other collectibles, books, or other market.

13. A method of communication between a seller and a potential buyer, the steps of the method comprising:
a. providing at least one server in communication with a data network,
b. receiving at the at least one server a user input from the seller, wherein the user input from the seller includes at least one universal price code (UPC) in the form of at least one of an image, an audio clip, a text description,
c. producing price information based on the UPC received by comparison to a specialized database,
d. publishing the price information to the at least one server using the data network in the form of an offer to buy,
e. viewing the offer to buy by the potential seller on a computing device.

14. A system for communication between a seller and a potential buyer, the system comprising:
at least one server in communication with a data network, the at least one server configured to receive and store a user input from the seller, the user input from the seller including at least one universal price code (UPC), the at least one server publishing a query to the server, the query including at least a portion of the user input from the seller; and
a first computing device in communication with the at least one server using the data network, the computing device configured to produce price information based on the at least one UPC, the at least one server making the price information available on the at least one server.

15. The system for communication according to claim 14, further comprising a mobile phone where the seller can view the price information.

16. The system for communication according to claim 14, wherein the at least a portion of the first user input included in the price information produced is based on a preference of the seller.

17. The system for communication according to claim 14, wherein the at least one server receives a user input from the potential buyer and the at least one server, in response to the user input from the potential buyer, sends a notification to the seller.

18. The system for communication according to claim 17, wherein the notification comprises one of a message written by the potential buyer, a contact information of the potential buyer, and a counteroffer.

19. The system for communication according to claim 14, wherein the at least one server receives a user input from the seller and the at least one server in response to the user input from the potential seller, sends a notification to the buyer.

20. The system for communication according to claim 19, wherein the notification comprises one of a message written by the potential seller, a contact information of the potential seller, and a counteroffer.
